(19) United States
(12) Patent Application Publication
(10) Pub. No.: US 2026/0012851 A1
(43) Pub. Date: Jan. 8, 2026

(54) NON-TRANSITORY COMPUTER-READABLE RECORDING MEDIUM, ESTIMATION METHOD, AND INFORMATION PROCESSING APPARATUS

(71) Applicant: Fujitsu Limited, Kawasaki-shi (JP)

(72) Inventors: Natsuki ISHIKAWA, Yamato (JP); Yoshihiro OKAWA, Yokohama (JP); Jun KAKUTA, Yokohama (JP); Masatoshi OGAWA, Zama (JP)

(73) Assignee: Fujitsu Limited, Kawasaki-shi (JP)

(21) Appl. No.: 19/255,509

(22) Filed: Jun. 30, 2025

(30) Foreign Application Priority Data
Jul. 3, 2024 (JP) 2024-107656

(51) Int. Cl. H04W 28/08; H04W 52/02

(52) U.S. Cl. CPC H04W 28/0958; H04W 52/0203

(57) ABSTRACT

A non-transitory computer-readable recording medium stores therein a program that causes a computer to execute an estimation process including solving, by using a predetermined term, a plurality of optimization problems of a traffic distribution within a predetermined area based on used bandwidth and throughput of base stations in operation within the predetermined area, calculating a similarity between a plurality of candidates of the traffic distribution within the predetermined area, the candidates being solutions of the optimization problem, selecting one traffic distribution from the candidates of the traffic distribution within the predetermined area based on the calculated similarity, and outputting the selected traffic distribution as the traffic distribution within the predetermined area.

### CROSS-REFERENCE TO RELATED APPLICATION

This application is based upon and claims the benefit of priority of the prior Japanese Patent Application No. 2024-107656, filed on Jul. 3, 2024, the entire contents of which are incorporated herein by reference.

### FIELD

The embodiment discussed herein is related to a computer-readable recording medium, an estimation method, and an information processing apparatus.

### BACKGROUND

As a method for suppressing power consumption in a radio access network (RAN), there is, for example, suspension control for shifting some base stations (BSs) to a sleep mode. In addition, as one method of suspension control, it is conceivable to reduce the power consumption by setting as many BSs as possible to the sleep mode while ensuring the communication quality between the BS and a user equipment (UE) on the basis of the traffic situation based on the performance management data (PM data) obtained at the time of operating the BS.
Patent Literature 1: US 2002/0013152 A

### SUMMARY

According to an aspect of an embodiment, a non-transitory computer-readable recording medium stores therein a program that causes a computer to execute an estimation process. The process includes solving, by using a predetermined term, a plurality of optimization problems of a traffic distribution within a predetermined area based on used bandwidth and throughput of base stations in operation within the predetermined area, calculating a similarity between a plurality of candidates of the traffic distribution within the predetermined area, the candidates being solutions of the optimization problem, selecting one traffic distribution from the candidates of the traffic distribution within the predetermined area based on the calculated similarity, and outputting the selected traffic distribution as the traffic distribution within the predetermined area.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating a suspension control of a network;

FIG. 2 is an explanatory diagram illustrating balance between throughput and used bandwidth;

FIG. 3 is an explanatory diagram illustrating superposition of two-dimensional normal distributions;

FIG. 4 is an explanatory diagram illustrating expression of a traffic distribution;

FIG. 5 is a block diagram illustrating a functional configuration example of an information processing apparatus according to an embodiment;

FIG. 6 is a flowchart illustrating an operation example of the information processing apparatus according to an embodiment;

FIG. 7 is a flowchart illustrating an example of a traffic distribution generation process;

FIG. 8 is an explanatory diagram illustrating a calculation example;

FIG. 9 is an explanatory diagram illustrating a calculation example;

FIG. 10 is an explanatory diagram illustrating a calculation example; and

FIG. 11 is an explanatory diagram illustrating an example of a computer configuration.

### DESCRIPTION OF EMBODIMENTS

However, since PM data cannot be obtained from the sleeping BS, in the above-described conventional technology, the control is performed to stop transmission while the traffic situation in the coverage of the sleeping BS is unclear, and as a result, the performance of the suspension control may deteriorate. In addition, there is also a problem that it is difficult to obtain the power consumption reduction effect when the sleeping BS is periodically activated in order to confirm the traffic situation within the coverage of the sleeping BS.

Preferred embodiments will be explained with reference to accompanying drawings. In the embodiment, components having the same function are denoted by the same reference numerals, and redundant description will be omitted. Note that the computer-readable recording medium, the estimation method, and the information processing apparatus described in the following embodiments are merely examples, and do not limit the embodiments. In addition, the following embodiments may be appropriately combined within a range not contradictory.

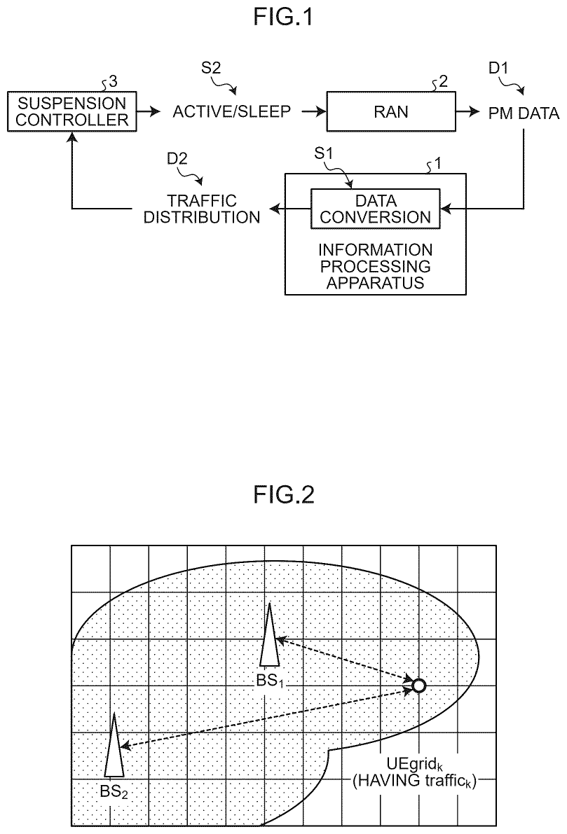

FIG. 1 is an explanatory diagram illustrating a suspension control of a network. As illustrated in FIG. 1, an information processing apparatus 1 according to the embodiment is an apparatus that performs data conversion (S1) on the basis of the position of each BS operating in the RAN 2 and PM data D1 and estimates a traffic distribution D2 in a target area. For example, a personal computer (PC) or the like can be applied as the information processing apparatus 1. Here, the target area is set in advance as a predetermined area for obtaining the traffic distribution, and for example, an area of several kilometers square is set.

The PM data D1 is data acquired at predetermined time intervals (every 5, 15, 30, or 60 minutes) during the operation of the BS. The PM data D1 includes information such as a resource block usage of the BS, an average throughput of the UE, and a delay. The traffic distribution D2 is data indicating traffic for each predetermined position (point) in the target area.

Based on the traffic distribution D2 estimated by the information processing apparatus 1, a suspension controller 3 performs suspension control in which each BS in the RAN 2 is set to active/sleep (S2). For example, the suspension controller 3 sets a BS covering an area with less traffic in the traffic distribution D2 as sleep, and sets a BS covering an area with more traffic as active. As a result, the suspension controller 3 reduces the power consumption by setting as many BSs as possible as the sleep mode while securing the communication quality between the BS and the UE.

The information processing apparatus 1 sets, for example, a grid for the target area, and it is assumed that the user equipment (UE) that communicates with the BS exists at each of a plurality of grid points of the grid. Hereinafter, the plurality of grid points in the target area is referred to as UEgrid. Note that the grid point (UEgrid) is an example of a predetermined position in the target area.

The UEgrid may be arbitrarily set in the target area. For example, the density of grid points may be increased in a densely populated area, and the density of grid points may be decreased in a sparsely populated area.

The information processing apparatus 1 according to the embodiment assumes that there is a UE at each grid point, and obtains traffic between each of the UEgrid and the BS. As a result, a spatial traffic distribution is obtained.

In the present embodiment, a relationship (balance) between the traffic of each of the UEgrid and the throughput and used bandwidth of the BS is assumed as follows. FIG. 2 is an explanatory diagram illustrating balance between throughput and used bandwidth. As illustrated in FIG. 2, traffic at a certain point (UEgridₖ) is denoted by trafficₖ.

As one of the assumptions, the trafficₖ is distributed to each BS according to UEgridₖ, the intensity between each BS, and the like. Specifically, as in the following equation (1), throughput (unit: bps) of a certain BS (for example, BS₁) is the sum of traffic allocated from all the UEgrid.

$$\begin{matrix}Throughput of {BS}_{1} = {\sum }_{k = 1}^{n} {P}_{k , 1} {traffic}_{k} \\ {P}_{k , 1} : Rate of {traffic}_{k} to be distributed to {BS}_{1}\end{matrix} \qquad ( 1 )$$

In addition, as one of the assumptions, UEgridₖ consumes bandwidth according to a signal-to-interference-plus-noise ratio (SINR) or the like with the connected BS when satisfying trafficₖ. Specifically, as in the following equation (2), the used bandwidth (unit: Hz) of a certain BS (for example, BS₁) is the sum of the bandwidth used by all the UEgrid in the BS.

$$\begin{matrix}Used bandwidth of {BS}_{1} = {\sum }_{k = 1}^{n} {R}_{k , 1} {traffic}_{k} \\ {R}_{k , 1} : Bandwidth [ Hz ] per bps used when {traffic}_{k} is processed in {BS}_{1}\end{matrix} \qquad ( 2 )$$

Here, the information on the left side of Equations (1) and (2) (throughput of the BS and used bandwidth) is obtained from the PM data D1.

The information processing apparatus according to the embodiment calculates intensity by a combination of all the UEgrid and the BS. The intensity is a value obtained by subtracting the path loss from the transmission power of the BS. The path loss can be calculated according to the content defined in 3rd Generation Partnership Project (3GPP) (registered trademark) or the like based on the position, frequency, height, and the like of the BS.

Next, the information processing apparatus according to the embodiment calculates a distribution ratio to each BS for each UEgrid on the basis of the intensity of each combination of all the UEgrid and the BS, and sets the distribution ratio as a matrix P.

For example, in the calculation of the distribution ratio, a rule is set in which the UE is connected to the BS having the maximum intensity, and for each UE, the BS having the maximum intensity is set to one, and the other BSs are set to zero. In addition, the calculation of the distribution ratio is not limited to the above, and may be appropriately determined on the basis of a connection rule at the time of network operation. For example, the UE may have a rule of connecting to a plurality of BSs in descending order of intensity. In addition, an index for calculating the intensity may also be changed as desired.

Next, the information processing apparatus according to the embodiment calculates, for example, SINR as an index of communication quality for each combination of all the UEgrid and the BS.

Here, the information processing apparatus according to the embodiment sets a reciprocal of rate calculated based on the SINR and an element product of the matrix P as a matrix R. The rate is calculated as log₂ (1+SINR) or the like. Note that rate may be determined based on MCS.

In addition, if there is no condition that the traffic that cannot be processed is collected in the BS and the used bandwidth exceeds the entire bandwidth of the BS, a balance is obtained as in the following equation (3).

$$\begin{matrix}Px = y\_throughput \\ Rx = y\_band\end{matrix} \qquad ( 3 )$$

Here, x is a vector (the length is the number of UEgrid) representing traffic [bps] for each UE. y_throughput is a vector (the length is the number of BSs) representing the PM data D1 (throughput [bps]). y_band is a vector (the length is the number of BSs) representing the PM data D1 (used bandwidth [Hz]). The matrix P is a matrix (the size is the number of BSs and the number of UEgrid) that determines a distribution ratio to each BS, that is, a connection destination from the UE to the BS. The matrix R is a matrix (the size is the number of BSs and the number of UEgrid) representing the used bandwidth per velocity [Hz/bps].

The information processing apparatus 1 according to the embodiment obtains a vector x (traffic [bps] of each UEgrid), that is, the traffic distribution by solving an optimization problem in consideration of the balance between the throughput and the used bandwidth described above.

Here, the sizes of the matrices P and R are the number of BSs×the number of UEgrid. In a case where the number of UEgrid to be obtained is larger than the number of BSs or in a case where the rank of the matrices P and R is lowered, the number of unknowns is larger than the number of equations, and the solution is not fixed to one.

Therefore, in the information processing apparatus 1 according to the embodiment, as the nature of the traffic distribution, the solution of the optimization problem is limited on the assumption of spatial continuity in which the traffic of UEgrid having a short distance is assumed to have a close value.

Specifically, the information processing apparatus 1 according to the embodiment expresses the vector x representing the traffic [bps] for each of the UEgrid as the superposition of two-dimensional normal distributions (hereinafter, it may be simply referred to as normal distribution) centered on each UEgrid, and uses the scaling coefficient of each normal distribution as an optimization design variable.

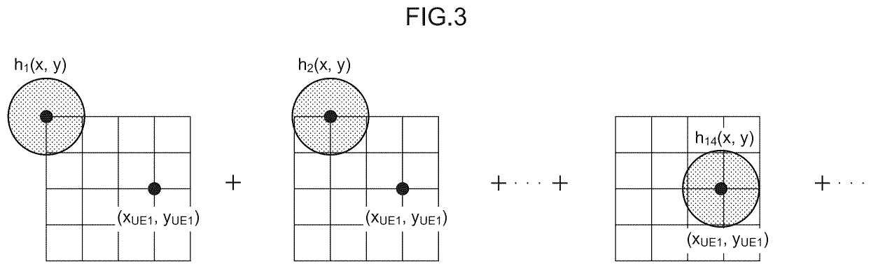

FIG. 3 is an explanatory diagram illustrating superposition of two-dimensional normal distributions. As illustrated in FIG. 3, traffic di of UEgrid₁ at a position (X_{UE1}, Y_{UE1}) is a sum of two-dimensional normal distributions h₁(x, y), h₂(x, y) . . . centered on each position. A calculation formula of the traffic di is as in the following equation (4).

$${d}_{1} = {\sum }_{k = 1}^{m} {h}_{k} ( {x}_{UE 1} , {y}_{UE 1} ) \qquad ( 4 )$$

Here, m is the number of UEgrid (number of positions). hₖ(x, y) is a two-dimensional normal distribution. For this two-dimensional normal distribution, the average is the position of each UEgridₖ, the diagonal term σ² of the variance-covariance matrix is the UEgrid distance, and the like, and the other elements of the variance-covariance matrix are zero. The scaling coefficient of the two-dimensional normal distribution is a design variable of optimization.

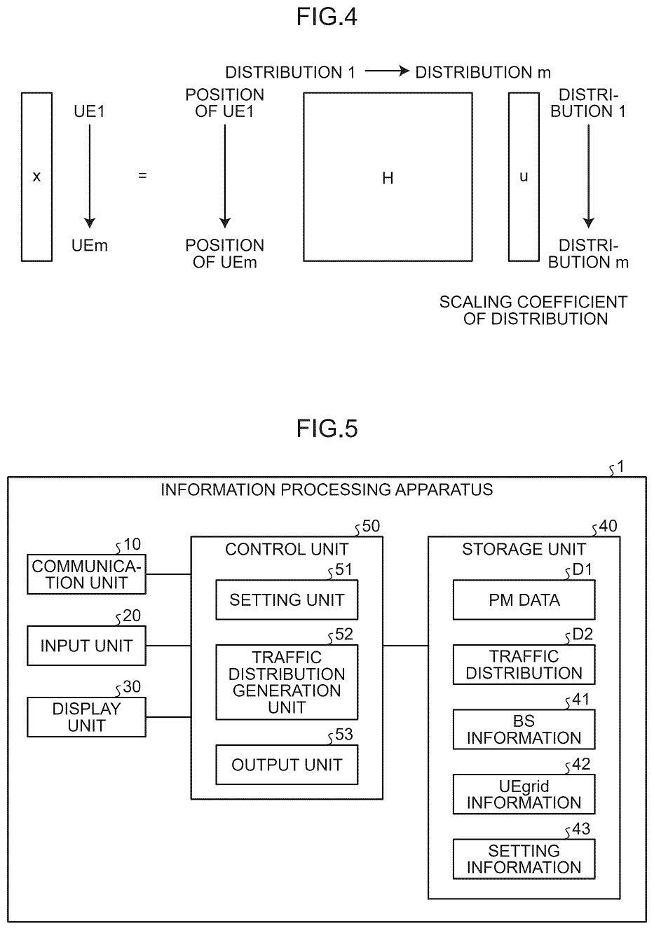

FIG. 4 is an explanatory diagram illustrating expression of the traffic distribution. As illustrated in FIG. 4, the information processing apparatus 1 according to the embodiment expresses the traffic distribution by superimposing two-dimensional normal distributions. Specifically, the information processing apparatus 1 according to the embodiment creates the matrix H in which the values at the respective UEgrid positions of the two-dimensional normal distribution centered on the respective UEgrid positions are stored.

Here, in the present embodiment, a scaling coefficient of each two-dimensional normal distribution is a vector u. Furthermore, in the present embodiment, the matrix A is represented by the following equation (5), and the vector y is represented by the following equation (6).

$$Matrix A = [ \begin{matrix}P \\ R\end{matrix} ] \qquad ( 5 )$$

$$Vector y = [ \begin{matrix}y\_throughput \\ y\_band\end{matrix} ] \qquad ( 6 )$$

Next, the information processing apparatus 1 according to the embodiment solves the optimization problem of the following inequality (7) for the vectors u and y and the matrix A described above.

$$\begin{matrix}{argmin}_{u} {‖ AHu - y ‖}^{2} & for u \geq 0\end{matrix} \qquad ( 7 )$$

Next, the information processing apparatus 1 according to the embodiment obtains the vector x, which is traffic of each of the UEgrid, as in the following equation (8).

$$x = Hu \qquad ( 8 )$$

Here, when the matrix H is created, σ², which is a diagonal term of the variance-covariance matrix of each two-dimensional normal distribution, is desired. The diagonal term of the variance-covariance matrix is an example of a predetermined term. In a case where the true traffic distribution can be acquired separately from the PM data D1 during the operation of the RAN 2, it can be determined that the value of σ² at which the accuracy of the generated traffic distribution D2 with respect to the true traffic distribution is high is optimal. However, it is generally difficult to obtain the true traffic distribution from the viewpoint of the cost of data measurement and storage.

Therefore, the information processing apparatus 1 according to the embodiment repeatedly solves the optimization problem by changing the optimization method (interior-point method, active-set method, sequential quadratic programming, etc.), changing the random number by the same optimization method, or the like, and obtains a plurality of solutions (candidates of traffic distribution).

Next, the information processing apparatus 1 according to the embodiment calculates the similarity between the plurality of solutions, that is, the similarity between the candidates of the traffic distribution, and outputs one candidate of the traffic distribution among the plurality of candidates of the traffic distribution as the traffic distribution estimated for the target area based on the calculated similarity. As a result, the information processing apparatus 1 according to the embodiment can obtain the traffic distribution D2 estimated to have a high calculated similarity and be close to the true traffic distribution even in a case where it is difficult to obtain the true traffic distribution because there is the sleeping BS or the like. Note that, since the two traffic distributions with different optimization methods for solving the optimization problem are sufficiently similar distributions and both are close to the true distribution, it is considered that there is no problem in any of the traffic distributions to be finally output. That is, it is considered that there is no performance difference in the traffic distribution to be finally output in the suspension control. The traffic distribution to be finally output may be an average of the two traffic distributions.

Specifically, the information processing apparatus 1 according to the embodiment selects a value of σ² at which the similarity of the traffic distribution becomes high, and outputs a candidate of the traffic distribution using the selected value of σ².

For example, the information processing apparatus 1 according to the embodiment prepares candidates of the optimization method (interior-point method, active-set method, sequential quadratic programming, etc.) and candidates of the value of σ² (σ² value=1, 2, 4 . . . ).

Next, the information processing apparatus 1 according to the embodiment solves an optimization problem for a combination of a candidate of an optimization method and a candidate of a value of σ², and generates a candidate of the traffic distribution.

Next, the information processing apparatus 1 according to the embodiment calculates the similarity between the candidates of the traffic distribution calculated by σ² of the same value for each σ² of the same value. The similarity is calculated, for example, according to the following equation (9).

$$Similarity of solutions of method 1 and 2 , {\hat{x}}_{method 1} , {\hat{x}}_{method 2} = \sqrt{\frac{1}{m} {\sum }_{k = 1}^{m} {( {\hat{x}}_{method 1} , {\hat{x}}_{method 2} )}^{2}} \qquad ( 9 )$$

In the equation (9), the similarity between the solution of the first optimization method (method1) and the solution of the second optimization method (method2) is calculated for σ² of the same value, and k corresponds to each element of the vector x. This similarity has a meaning in terms of distance between traffic distributions, and for example, the value becomes smaller as the traffic distributions are more similar (as the similarity is higher).

The information processing apparatus 1 according to the embodiment performs the above calculation for each combination of the candidates of the optimization method (three candidates if the number of candidates is three), and obtains an average for each σ² of the same value.

Note that the information processing apparatus 1 according to the embodiment may make a trial from σ² having a small value and select σ² in which the similarity is equal to or less than a predetermined threshold (the similarity is sufficiently high) or σ² in which the change in the similarity is equal to or less than the threshold. At this time, after selecting σ², the information processing apparatus 1 ends the trial (solving a plurality of problems).

If the solution is limited, for the case of σ² having the smaller value, it is possible to obtain the solution without introducing an unnecessary assumption. Therefore, the information processing apparatus 1 according to the embodiment can obtain an accurate solution (traffic distribution) by performing trial selection from σ² having a small value. In addition, the information processing apparatus 1 can omit an unnecessary trial by ending the trial (solving a plurality of problems).

Next, details of the information processing apparatus 1 according to the embodiment will be described. FIG. 5 is a block diagram illustrating a functional configuration example of the information processing apparatus 1 according to an embodiment.

As illustrated in FIG. 5, the information processing apparatus 1 includes a communication unit 10, an input unit 20, a display unit 30, a storage unit 40, and a control unit 50.

The communication unit 10 executes data communication with an external device or the like via a network. The input unit 20 receives an operation from a user. The display unit 30 displays a processing result of the control unit 50.

The storage unit 40 includes BS information 41, UEgrid information 42, and setting information 43 in addition to the PM data D1 and the traffic distribution D2 described above. For example, the storage unit 40 is realized by a memory or the like.

The BS information 41 is information related to each base station (BS). Specifically, the BS information 41 includes transmission power, frequency, position, height, and the like of each BS.

The UEgrid information 42 is information related to each of the UEgrid. Specifically, the UEgrid information 42 includes a position of each of the UEgrid. In a case where there is an observation value of traffic in the UEgrid at a specific time and position, the UEgrid information 42 also includes the information.

The setting information 43 is various setting values and the like used when the traffic distribution is obtained. For example, the setting information 43 includes a value (candidate value) related to the diagonal term (σ2) of the variance-covariance matrix of the normal distribution, a candidate of the optimization method (interior-point method, active-set method, sequential quadratic programming, etc.), and the like.

The control unit 50 includes a setting unit 51, a traffic distribution generation unit 52, and an output unit 53. For example, the control unit 50 is realized by a processor.

The setting unit 51 is a processing unit that performs various settings regarding the traffic distribution on the basis of data input via the communication unit 10, the input unit 20, and the like. Specifically, the setting unit 51 receives an input from the user via the communication unit 10, the input unit 20, and the like, and sets the positions of the plurality of grid points corresponding to the target area, the positions of the base stations, and the communication amount (PM data D1) of the base station at every predetermined time. The setting unit 51 stores the set contents in the storage unit 40 as the PM data D1, the BS information 41, the UEgrid information 42, and the setting information 43.

The traffic distribution generation unit 52 is a processing unit that performs the above-described calculation on the basis of the setting by the setting unit 51 and estimates the communication amount of each UEgrid at a predetermined time, that is, the traffic distribution D2. The traffic distribution generation unit 52 stores the estimated traffic distribution D2 in the storage unit 40.

The output unit 53 is a processing unit that reads the traffic distribution D2 generated (estimated) by the traffic distribution generation unit 52 from the storage unit 40 and outputs the traffic distribution D2 to the suspension controller 3 via the communication unit 10.

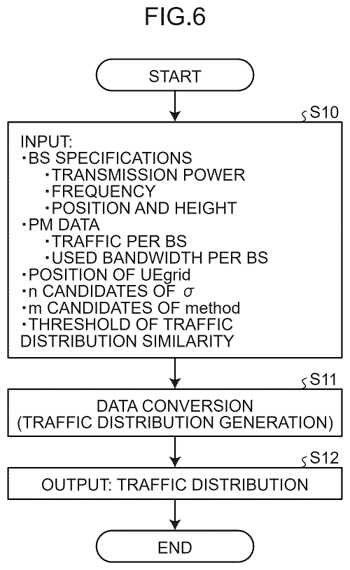

FIG. 6 is a flowchart illustrating an operation example of the information processing apparatus 1 according to an embodiment. As illustrated in FIG. 6, the setting unit 51 receives the BS information 41 regarding specifications of each BS (transmission power, frequency, position, height, and the like) by an input from the user or the like. In addition, the setting unit 51 receives the PM data D1 (traffic per BS, used bandwidth per BS, etc.) related to the BS in operation. In addition, the setting unit 51 receives the setting information 43 such as a position of UEgrid, (n) candidates of σ, (m) candidates of an optimization method (method), and a threshold of traffic distribution similarity (S10). The setting unit 51 stores the received setting contents in the storage unit 40 as the PM data D1, the BS information 41, the UEgrid information 42, and the setting information 43.

Next, the traffic distribution generation unit 52 performs data conversion (traffic distribution generation) into the traffic distribution D2 on the basis of the PM data D1, the BS information 41, the UEgrid information 42, and the setting information 43 stored in the storage unit 40 (S11). Next, the output unit 53 outputs the traffic distribution D2 generated by the traffic distribution generation unit 52 to the suspension controller 3 (S12).

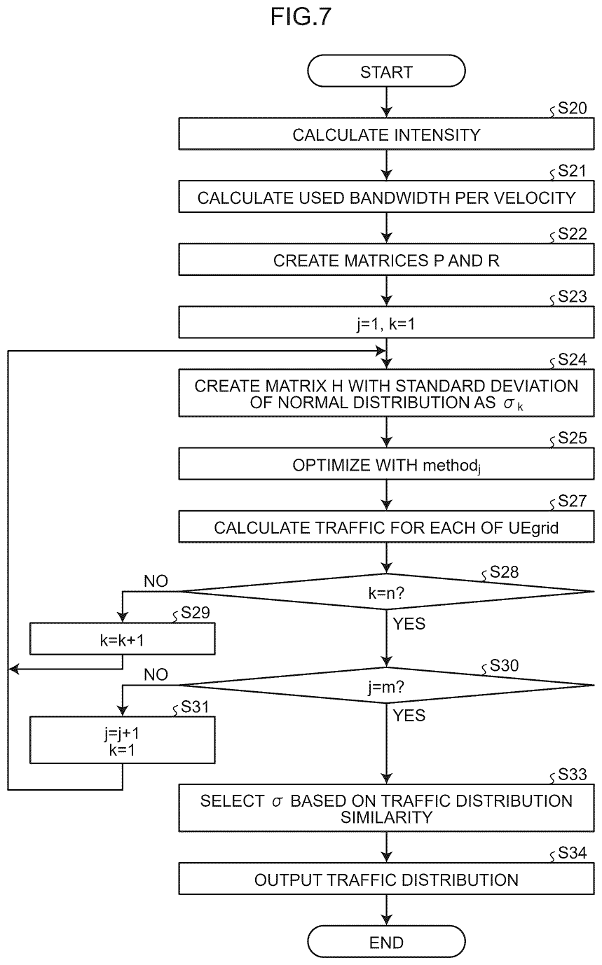

FIG. 7 is a flowchart illustrating an example of a traffic distribution generation process. As illustrated in FIG. 7, when the traffic distribution generation process is started, the traffic distribution generation unit 52 calculates intensity by a combination of all the UEgrid and the BS (S20).

Next, the traffic distribution generation unit 52 calculates the used bandwidth per velocity (S21) and creates the above-described matrices P and R (S22). Next, the traffic distribution generation unit 52 initializes the variables j and k to j=1 and k=1 (S23), and performs processes (S24 to S30) of solving a plurality of optimization problems by a combination of (n) candidates of σ and (m) candidates of the optimization method (method).

Specifically, the traffic distribution generation unit 52 creates the above-described matrix H with the standard deviation of the normal distribution as σₖ (S24). Next, the traffic distribution generation unit 52 solves the optimization problem related to the inequality (7) described above using methodⱼ among the candidates of the optimization method (method) and performs optimization (S25). Next, the traffic distribution generation unit 52 calculates traffic for each UEgrid as in the above-described equation (8) (S27).

Next, the traffic distribution generation unit 52 determines whether or not k=n (S28), and if k=n is not satisfied (S28: No), it increments according to k=k+1 (S29), and the process returns to S24.

If k=n (S28: Yes), the traffic distribution generation unit 52 determines whether or not j=m (S30), and if j=m is not satisfied (S30: No), it increments according to j=j+1 and sets k=1 (S31), and the process returns to S24.

If j=m (S30: Yes), the traffic distribution generation unit 52 calculates the similarity between the plurality of calculated candidates of the traffic distribution for each σ having the same value by the above-described equation (9). Next, the traffic distribution generation unit 52 selects a value of σ at which the similarity of the traffic distribution is the highest (S33). Next, the traffic distribution generation unit 52 outputs a traffic distribution candidate using the selected value of σ as the estimated traffic distribution D2 (S34), and ends the process.

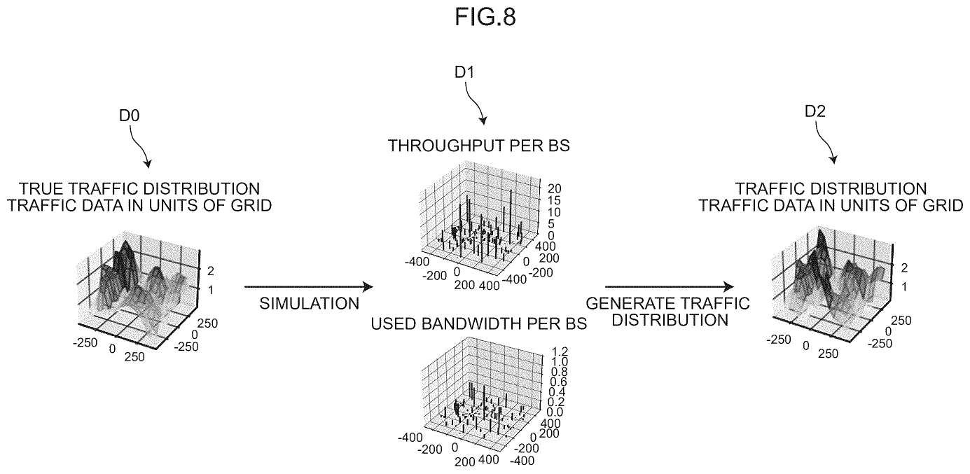

FIGS. 8 to 10 are explanatory diagrams illustrating calculation examples. As illustrated in FIG. 8, in the present calculation example, the PM data D1 is obtained by simulation from traffic data (original data D0) in units of grid indicating true traffic distribution. In this simulation, the connection between the UE and the BS is set such that the UE is connected to the BS having the highest intensity.

Then, in the present calculation example, the traffic distribution D2 is obtained based on the PM data D1 using the information processing apparatus 1 according to the embodiment. Here, rate (bps/Hz) between the UE and the BS is calculated as log₂ (1+SINR). In the present calculation example, the accuracy of the estimated traffic distribution D2 is verified by comparing the traffic distribution D2 with the original data D0 indicating the true traffic distribution.

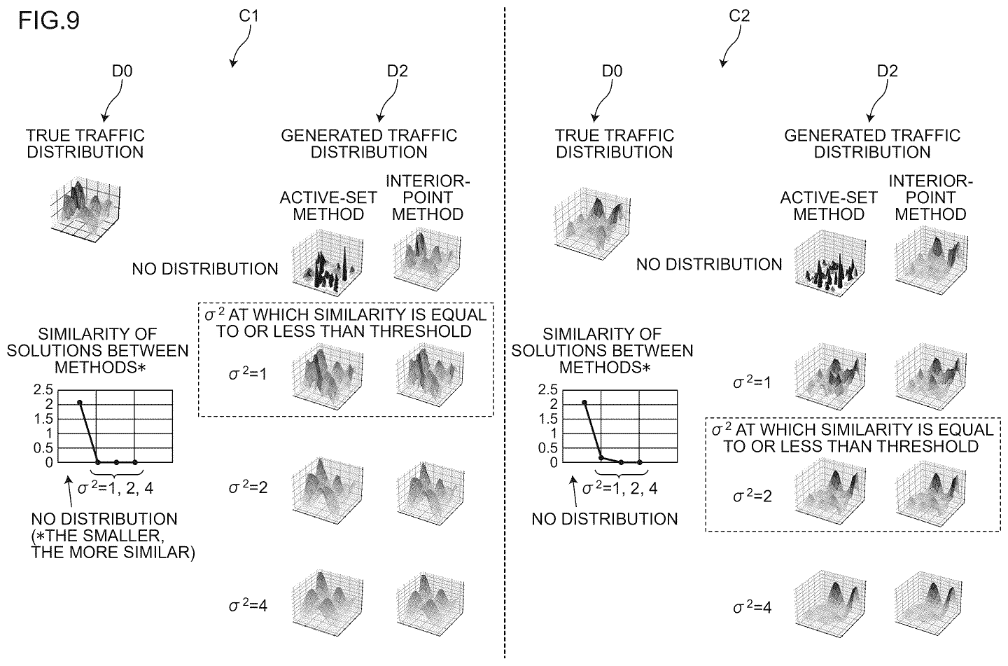

As illustrated in FIG. 9, cases C1 and C2 are calculation examples in which traffic distribution D2 is calculated in ascending order of σ^{2=1, 2}, and 4 for different areas (target areas). In the case C1, when σ²⁼¹, it is equal to or less than a threshold (here, 0.05) set in advance in the setting information 43. Therefore, in the case C1, in a case where the traffic distribution D2 is calculated in ascending order of σ^{2=1, 2}, and 4, the information processing apparatus 1 outputs the traffic distribution D2 when σ²⁼¹, which is equal to or less than the threshold, to the suspension controller 3.

Similarly, in the case C2, when σ²⁼², it is equal to or less than the threshold (here, 0.05) set in advance in the setting information 43. Therefore, in the case C2, in a case where the traffic distribution D2 is calculated in ascending order of σ^{2=1, 2}, and 4, the information processing apparatus 1 outputs the traffic distribution D2 when σ²⁼², which is equal to or less than the threshold, to the suspension controller 3.

In both cases C1 and C2, the traffic distribution D2 output to the suspension controller 3 has a shape similar to the traffic distribution of the original data D0, and an accurate estimation result is obtained.

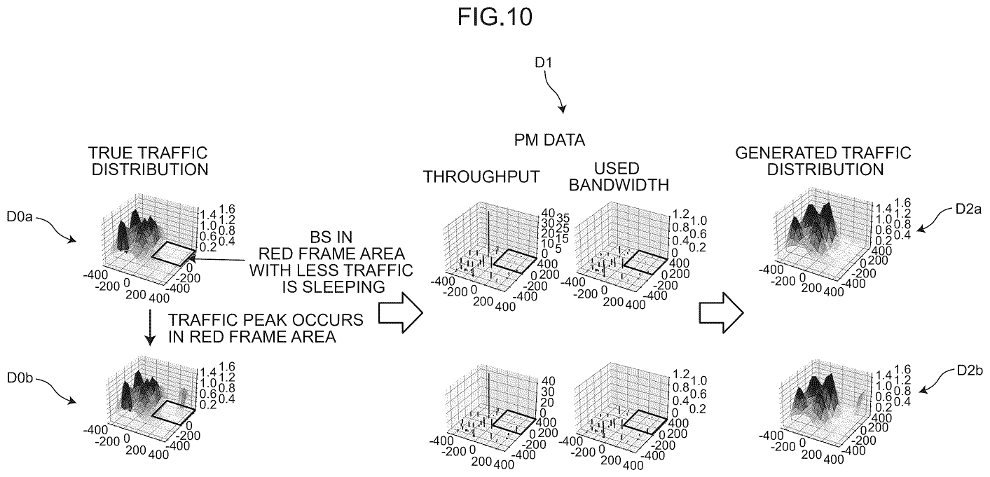

Further, as illustrated in FIG. 10, in original data D0a and D0b, a traffic peak occurs in the original data D0b in an area within a frame in which the BS is sleeping. Even in such a case, the traffic peak can be reproduced in the traffic distribution D2b estimated from the PM data D1 of the original data D0b.

As described above, the information processing apparatus 1 solves a plurality of optimization problems of the traffic distribution within a predetermined area using predetermined terms on the basis of the used bandwidth and the throughput of the base station (BS) in operation within the predetermined area (target area). The information processing apparatus 1 calculates similarity between candidates for a plurality of traffic distribution candidates within a predetermined area, which are a plurality of solutions of the optimization problems. The information processing apparatus 1 selects one traffic distribution from traffic distribution candidates within the predetermined area on the basis of the calculated similarity, and outputs the selected traffic distribution as a traffic distribution within the predetermined area.

As a result, the information processing apparatus 1 can obtain the traffic distribution D2 estimated to be close to the true traffic distribution on the basis of the similarity between the plurality of candidates of the traffic distribution even in a case where there is a BS that has gone to sleep or the like.

In addition, the information processing apparatus 1 solves a plurality of optimization problems by varying the method of solving the optimization problems and/or the value of a predetermined term. As a result, the information processing apparatus 1 can obtain a plurality of candidates for the traffic distribution.

Furthermore, the information processing apparatus 1 calculates the similarity between the plurality of candidates solved using the predetermined term of the same value for each value of the predetermined term. The information processing apparatus 1 selects one traffic distribution candidate using a predetermined value for a predetermined term from among a plurality of candidates of the traffic distribution within a predetermined area on the basis of the similarity calculated for each value of the predetermined term. As a result, the information processing apparatus 1 can appropriately select a value of the predetermined term used for the optimization problem and select the traffic distribution using the value.

Furthermore, the information processing apparatus 1 solves the optimization problem by varying the values of the predetermined terms in ascending order. As a result, the information processing apparatus 1 can obtain a solution in ascending order of the value of the predetermined term used for the optimization problem, that is, without introducing an unnecessary assumption.

Furthermore, in a case where the similarity calculated by varying the value of the predetermined term in ascending order satisfies a predetermined condition, the information processing apparatus 1 selects one traffic distribution candidate from among a plurality of candidates of the traffic distribution obtained by varying the value of the predetermined term in ascending order, and ends the solving a plurality of problems. As a result, in the information processing apparatus 1, an unnecessary trial (solving a plurality of problems) can be omitted.

Note that each component of each device illustrated in the drawings may be physically configured other than as illustrated in the drawings. That is, a specific form of variance and integration of each device is not limited to the illustrated form, and all or a part thereof can be functionally or physically dispersed and integrated in an arbitrary unit according to various loads, usage conditions, and the like.

For example, regarding the constraint of the solution of the optimization problem, the above embodiment exemplifies the case of limiting the output solution on the assumption of spatial continuity. However, the output solution may be limited on the assumption of a correlation (temporal continuity) that traffic at close times at each lattice point should have values close to each other. As an example, in a case where a solution to be output is limited on the assumption of temporal continuity, the two-dimensional normal distribution regarding the traffic described above may be extended to a three-dimensional normal distribution to which a time axis is added.

In solving the optimization problem, constraints and conditions other than the spatial and temporal correlation may be added to solve the optimization problem. As an example, an area may be set for the traffic value of UEgrid. In addition, when an observation value of traffic of UEgrid at a specific time and position is included in the UEgrid information 42, the value may be applied to the optimization problem. In addition, in the UEgrid in which the number of UEs is zero, the value of the traffic may be set to zero.

In addition, since traffic of UEgrid is expressed by superposition of distribution functions (normal distribution), traffic at a position other than the defined UEgrid and at a time other than the time when PM data is collected can also be calculated.

In addition, the normal distribution may be substituted by a radiation basis function. In addition, the arrangement of the UEgrid may be other than in a grid shape and may be a way of giving such that a traffic distribution can be obtained covering the entire target region (for example, dense dots corresponding to population density or the like). In addition, the present embodiment can also be applied to a case where the coverage of the macro BS and the coverage of the small BS overlap as in a heterogeneous network.

In addition, for generation of the traffic distribution, consideration may be placed only on throughput balance or only on used bandwidth balance. In a case where the traffic distribution is generated in consideration of both the throughput balance and the used bandwidth balance, weighting of which is emphasized may be performed by multiplying each of the throughput and the used bandwidth by a predetermined coefficient.

In addition, for the generation of the traffic distribution, the balance of the use time of the BS may be considered instead of the used bandwidth balance. For example, in a case where the traffic distribution is generated in consideration of the balance of the use time of the BS, an index that can reflect the load applied to the BS, such as the SINR representing the communication quality, may be used.

Furthermore, all or any part of the various processing functions of the setting unit 51, the traffic distribution generation unit 52, and the output unit 53 performed by the control unit 50 of the information processing apparatus 1 may be executed on a CPU (or a micro computer such as an MPU or a micro controller unit (MCU)). Furthermore, needless to say, all or any part of the various processing functions may be executed on a program analyzed and executed by a CPU (or a micro computer such as an MPU or an MCU) or on hardware by wired logic. In addition, various processing functions performed by the information processing apparatus 1 may be executed by a plurality of computers in cooperation by cloud computing.

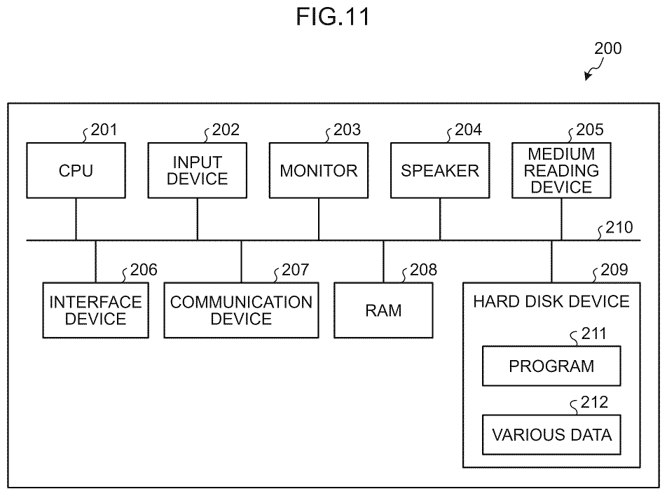

The various processes described in the above embodiment can be realized by executing a program prepared in advance on a computer. Therefore, an example of a computer configuration (hardware) for executing a program having a function similar to that of the above embodiment will be described below. FIG. 11 is an explanatory diagram illustrating an example of a computer configuration.

As illustrated in FIG. 11, a computer 200 includes a CPU 201 that executes various types of arithmetic processing, an input device 202 that receives an input of data, a monitor 203, and a speaker 204. Furthermore, the computer 200 includes a medium reading device 205 that reads a program and the like from a storage medium, an interface device 206 for connecting to various devices, and a communication device 207 for communicating and connecting to an external device in a wired or wireless manner. In addition, the computer 200 includes a RAM 208 that temporarily stores various types of information and a hard disk device 209. In addition, each unit (201 to 209) in the computer 200 is connected to a bus 210.

The hard disk device 209 stores a program 211 for executing various processes in the functional configuration (for example, the setting unit 51, the traffic distribution generation unit 52, and the output unit 53) described in the above embodiment. In addition, the hard disk device 209 stores various data 212 referred to by the program 211. The input device 202 receives an input of operation information from an operator, for example. The monitor 203 displays, for example, various screens operated by the operator. For example, a printing device or the like is connected to the interface device 206. The communication device 207 is connected to a communication network such as a local area network (LAN), and exchanges various types of information with an external device via the communication network.

The CPU 201 reads the program 211 stored in the hard disk device 209, develops the program in the RAM208, and executes the program, thereby performing various processes related to the described-above functional configuration (for example, the setting unit 51, the traffic distribution generation unit 52, and the output unit 53). Note that the program 211 may be stored other than in the hard disk device 209. For example, the program 211 stored in a storage medium readable by the computer 200 may be read and executed. The storage medium readable by the computer 200 corresponds to, for example, a portable recording medium such as a CD-ROM, a DVD disk, or a universal serial bus (USB) memory, a semiconductor memory such as a flash memory, a hard disk drive, or the like. Alternatively, the program 211 may be stored in a device connected to a public line, the Internet, a LAN, or the like, and the computer 200 may read and execute the program 211 from the device.

According to one embodiment, the traffic distribution can be accurately estimated.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute an estimation process comprising:
solving, by using a predetermined term, a plurality of optimization problems of a traffic distribution within a predetermined area based on used bandwidth and throughput of base stations in operation within the predetermined area;
calculating a similarity between a plurality of candidates of the traffic distribution within the predetermined area, the candidates being solutions of the optimization problem;
selecting one traffic distribution from the candidates of the traffic distribution within the predetermined area based on the calculated similarity; and
outputting the selected traffic distribution as the traffic distribution within the predetermined area.

2. The non-transitory computer-readable recording medium according to claim 1, wherein
the solving the plurality of optimization problems includes solving the plurality of optimization problems by varying a method of solving the optimization problems and/or a value of the predetermined term.

3. The non-transitory computer-readable recording medium according to claim 1, wherein
the calculating includes calculating similarity between the plurality of candidates solved using the predetermined term having the same value, for each value of the predetermined term, and
the selecting selects one traffic distribution candidate using a predetermined value for the predetermined term from among a plurality of candidates of the traffic distribution within the predetermined area based on a similarity calculated for each value of the predetermined term.

4. The non-transitory computer-readable recording medium according to claim 2, wherein
the solving the plurality of optimization problems includes solving the optimization problems by varying the value of the predetermined term in ascending order.

5. The non-transitory computer-readable recording medium according to claim 4, wherein
the selecting selects, in a case where the similarity calculated by varying the value of the predetermined term in ascending order satisfies a predetermined condition, one traffic distribution candidate from among the plurality of candidates of traffic distribution obtained by varying the value of the predetermined term in ascending order, and ends the solving the plurality of optimization problems.

6. The non-transitory computer-readable recording medium according to claim 1, wherein
the predetermined term is a term relating to variance of traffic distribution within the predetermined area.

7. An estimation method comprising:
solving, by using a predetermined term, a plurality of optimization problems of a traffic distribution within a predetermined area based on used bandwidth and throughput of base stations in operation within the predetermined area;
calculating a similarity between a plurality of candidates of the traffic distribution within the predetermined area, the candidates being solutions of the optimization problem;
selecting one traffic distribution from the candidates of the traffic distribution within the predetermined area based on the calculated similarity; and
outputting the selected traffic distribution as the traffic distribution within the predetermined area, using a processor.

8. The estimation method according to claim 7, wherein
the solving the plurality of optimization problems includes solving the plurality of optimization problems by varying a method of solving the optimization problems and/or a value of the predetermined term.

9. The estimation method according to claim 7, wherein
the calculating includes calculating similarity between the plurality of candidates solved using the predetermined term having the same value, for each value of the predetermined term, and
the selecting selects one traffic distribution candidate using a predetermined value for the predetermined term from among a plurality of candidates of the traffic distribution within the predetermined area based on a similarity calculated for each value of the predetermined term.

10. The estimation method according to claim 8, wherein
the solving the plurality of optimization problems includes solving the optimization problems by varying the value of the predetermined term in ascending order.

11. The estimation method according to claim 10, wherein
the selecting selects, in a case where the similarity calculated by varying the value of the predetermined term in ascending order satisfies a predetermined condition, one traffic distribution candidate from among the plurality of candidates of traffic distribution obtained by varying the value of the predetermined term in ascending order, and ends the solving the plurality of optimization problems.

12. The estimation method according to claim 7, wherein
the predetermined term is a term relating to variance of traffic distribution within the predetermined area.

13. An information processing apparatus comprising:
a processor configured to:
solve, by using a predetermined term, a plurality of optimization problems of a traffic distribution within a predetermined area based on used bandwidth and throughput of base stations in operation within the predetermined area;
calculate a similarity between a plurality of candidates of the traffic distribution within the predetermined area, the candidates being solutions of the optimization problem;
select one traffic distribution from the candidates of the traffic distribution within the predetermined area based on the calculated similarity; and
output the selected traffic distribution as the traffic distribution within the predetermined area.

14. The information processing apparatus according to claim 13, wherein
the processor is further configured to solve the plurality of optimization problems by varying a method of solving the optimization problems and/or a value of the predetermined term.

15. The information processing apparatus according to claim 13, wherein
the processor is further configured to:
calculate similarity between the plurality of candidates solved using the predetermined term having the same value, for each value of the predetermined term, and
select one traffic distribution candidate using a predetermined value for the predetermined term from among a plurality of candidates of the traffic distribution within the predetermined area based on a similarity calculated for each value of the predetermined term.

16. The information processing apparatus according to claim 14, wherein
the processor is further configured to solve the optimization problems by varying the value of the predetermined term in ascending order.

17. The information processing apparatus according to claim 16, wherein
the processor is further configured to
select, in a case where the similarity calculated by varying the value of the predetermined term in ascending order satisfies a predetermined condition, one traffic distribution candidate from among the plurality of candidates of traffic distribution obtained by varying the value of the predetermined term in ascending order, and ends the solving the plurality of optimization problems.

18. The information processing apparatus according to claim 13, wherein
the predetermined term is a term relating to variance of traffic distribution within the predetermined area.
